(19) United States
(12) Patent Application Publication
(10) Pub. No.: US 2006/0241943 A1
(43) Pub. Date: Oct. 26, 2006

(54) Medical vocabulary templates in speech recognition

(76) Inventors: Anuthep Benja-Athon, New York, NY (US); Sirikit Benja-Athon, New York, NY (US)

Correspondence Address: Anuthep Benja-Athon, 210 E. 36th St., New York, NY, 10016, US

(21) Appl. No.: 11/477,121

(22) Filed: Jun. 29, 2006

Related U.S. Application Data
(63) Continuation-in-part of application No. 11/255,229, filed on Oct. 21, 2005.
Application No. 11/255,229 is a continuation-in-part of application No. 11/114,763, filed on Apr. 27, 2005.
Application No. 11/114,763 is a continuation-in-part of application No. 11/074,236, filed on Mar. 7, 2005.
Application No. 11/114,763 is a continuation-in-part of application No. 11/059,088, filed on Feb. 16, 2005.

(51) Int. Cl. G10L 15/26

(52) U.S. Cl. 704/235

(57) ABSTRACT

A system of templates of words and terms use in medicine and surgery by physicians for optimizing the outcomes of speech recognition process of converting digital voice data produced by physicians into digital text data comprises words and terms use in medical and surgical specialties. The medical and surgical vocabulary templates comprise individual logical arrangements or orders of related words and terms use by physicians to communicate and record health and health-care information and data.

This application is a continuation-in-part of Ser. No. 11/255,229 entitled the Best method of computerized transcriptions filed Oct. 21, 2005 which is continuation-in-part of Ser. No. 11/114,763 entitled System of Influencing Health-Care Utilizations filed Apr. 27, 2005 which is a continuation-in-part of Ser. No. 11/074,236 entitled System of Health-Care Resources file Mar. 7, 2005 and Ser. No. 11/059,088 entitled Consumers Buyers-Physicians Health-Care filed Feb. 16, 2005 which are pending.

### FIELD OF INVENTION

A system of templates of medical vocabulary for optimizing speech recognition in health-care.

### BACKGROUND OF THE INVENTION

To date, the present invention is the most advanced innovation enabling the most effective and practical applications of speech recognition technology in medicine and health-care.

Application Ser. No. 11/255,229 entitled the Best method of computerized transcriptions filed Oct. 21, 2005 significantly increases the accuracy of the outcomes of the computerized conversions of digital audio or voice data produced by physicians to digital text data. Thus, said invention provides for physicians, computers and servers greater than 80% accuracy of voice-to-text conversions. However, present invention further improve upon and even more enhance the performance of its predecessor by providing an improved or better refined version for computerized conversions of physicians' digital audio or voice data to digital text data.

Thus, the present invention will certainly cause the rapid and widespread applications of the best health-care system for improving the American health-care with all the human and socioeconomic benefits for all Americans and the world as provide by the earlier pending patent applications of these physician applicant and his co-applicants.

Therefore, true to the spirit of its predecessor, the present invention provides a yet improved system for accurately and rapidly converting massive data on health and health-care information on hundred of millions of patients generate by the millions of brains of physicians into digital data. The earlier and present inventions of these patent applicants are the only systems of causing physicians in America and the world to adopt and practice the processes of converting the products of their thought processes on the data on health and health-care information on their patients into computer digital data.

These patent applicants' earlier and present invention's benefits and benevolent affects on humanity are immense as the set inventions will surely cause billions of health-care dollars, tangible and intangible benefits per day to positively affect and improve the lives of millions of people in America and the world. The current health-care crisis is therefore resolved by this physician applicant and his co-applicants.

### SUMMARY OF THE INVENTION

The present invention is a system of hundreds or thousands of templates of words and terms use in medicine and surgery by physicians and other health-care providers for optimizing or improving the accuracy of the outcomes of speech recognition process of converting digital voice data produced by physicians into digital text data comprises words and terms use in medical and surgical specialties by said physicians. The medical and surgical vocabulary templates comprise hundreds or thousands of individual logical arrangements, orders or hierarchies of related medical and surgical words and terms use by physicians to communicate and record health and health-care information and data. In the speech recognition process of converting physicians' digital voice data into digital text data for further processing to improve the quality of health-care for thousands of physicians and millions or billions of people, the present invention provides the grammars and rules of using templates of medical and surgical vocabularies and the like use by physicians and other health-care providers to the physicians and computer programs and software use by and in computers and servers.

Adaptations, editions and improvements including rearrangements, reordering, re-associating, adding and subtracting related words, terms, phrases, acronyms, synonyms and codes in each and every template can be constantly done or achieved to fulfill the needs, applications or requirements of the physicians to achieve the goals and objectives of the present invention.

### DESCRIPTION OF THE PREFERRED EMBODIMENTS

Since the filing of said patent applications, more research and further refinement of the present patent applicants' creativity have resulted in the present patent application for further optimizing or improving the accuracy and outcomes of the speech recognition process of converting digital voice data generated by physicians to digital text data.

First, one of the preferred embodiments of the present invention is the applications and uses of vocabulary use by physicians and in medicine, surgery and health-care. The present invention provides the organizations of medical and surgical vocabulary comprising words, terms, phrases, acronyms, synonyms and codes—see infra—under categories, headings or the like in medicine and surgery such as, but not limited to, Complaint or Chief Complaint, Duration, Diagnosis, Differential Diagnosis, Prescription and dosages, Test, Treatment, Surgery, Recommendation, Referral and related, etc.

Consequently, one of the preferred embodiments of the present invention is the orders or arrangements of categories or headings infra comprising medical words, terms, phrases, acronyms and/or synonyms comprising complaints or chief complaints, durations, diagnoses, differential diagnoses, prescriptions and dosages, tests, treatments, surgeries, recommendations, referrals, codes—see infra—and related, etc., use by about 600,000 American physicians practicing about 80 medical and surgical specialties. Each of said complaints or chief complaints, durations, diagnoses, differential diagnoses, prescriptions and dosages, tests, treatments, surgeries, recommendations, referrals and codes comprises hundreds or thousands of said words, phrases, sentences, means for representing sets of data and any combination thereof.

To improve the outcomes of speech recognition process of converting digital voice data produced by physicians into digital text data, one of the preferred embodiments of the present invention comprises a plurality of hierarchies, orders, arrangements or templates of related words, terms, phrases, codes, acronyms and synonyms use in the medical and surgical specialties and health-care. Thus, the present invention provides hierarchies, orders, arrangements or templates of related words, terms, phrases, codes, acronyms and synonyms present in more than medical and surgical dictionaries and thesauruses use by physicians practicing about 80 medical and surgical specialties. It is understood that some words, terms, phrases, codes, acronyms and synonyms provide by the present invention may, can or will be formed or generated by physicians or other health-care providers to fulfill his, her or their needs, applications or demands

Moreover, there is a similar or specific organization or order of headings and categories in said hierarchies, orders, arrangements or templates of words, terms, phrases, acronyms, synonym and codes. However, each of said hierarchies, orders, arrangements or templates predominantly comprises words, terms, phrases, acronyms, synonyms, codes and sentences which are or use in a medical or surgical specialty.

Furthermore, each of said hierarchies of words, terms, phrases, acronyms, synonyms and codes of a medical or surgical specialty may or does comprise or include words, terms, phrases, acronyms, synonyms and codes from a plurality of medical and surgical specialties.

In addition, a physician in a medical or surgical specialty can have a hierarchy, order, arrangement or template or hierarchies, orders, arrangements or templates of related words, terms, phrases, acronyms, synonyms and codes for a particular physician. In other words, for example, if there are 100,000-500,000 physicians in U.S.A. using the present invention, the present invention provides hierarchies, orders, arrangements or templates of related words, terms, phrases, acronyms, synonyms, codes and sentences for a physician, a group of physicians, groups of physicians and organizations of physicians in all medical and surgical specialties to achieve the objectives and goals of the present invention.

It is understood time, dates and duration are provided by the present invention.

Adaptations, editions and improvements including rearrangements, reordering, re-associating, adding and subtracting related words, terms, phrases, acronyms, synonyms and codes in each and every template can be constantly and versatilely done or achieved to fulfill the needs, applications or requirements of the physicians described herein to achieve the goals and objectives of the present invention. Thus, although hundreds or thousands of pre-defined templates are provided according to the spirit and scope of the claims of the present invention, but the contents of said templates are not fixed as said adaptations, editions and improving can be versatilely and constantly—if needs arise—made to said templates to fulfill the needs, applications or requirements of said physicians to achieve the goals and objectives of the present invention.

One of the possible permutations of just one hierarchy of related words, terms and phrases of a medical specialty among about 80 medical specialties such as Allergy of the present invention is the links of all the complaints or chief complaints, durations, diagnoses, differential diagnoses, treatments, prescriptions including dosages, treatments and surgeries. Furthermore, related words, terms and phrases being used in other medical specialties will be appropriately and logically included in said relationships base on medicine or surgery.

Second, the present invention provides orders or arrangements of relationships of complaints or chief complaints, durations, diagnoses, differential diagnoses, prescriptions and dosages, tests, treatments, surgeries, recommendations, referrals, a means for representing sets of data based on medicine and surgery. Therefore, one of the preferred embodiments of the present invention is the orders, arrangements, links or webs of relationships of all headings such as, but not limited to, Complaint or Chief Complaint, Duration, Diagnosis, Differential Diagnosis, Prescription and dosages, Test, Treatment, Surgery, Recommendation, Referral, and related, etc. Thus, orders, arrangements, links or webs of relationships of medical words, terms, phrases and codes encompassing said complaints or chief complaints, durations, diagnoses, differential diagnoses, prescriptions and dosages, tests, treatments, surgeries, recommendations, referrals, codes—see infra, and related, etc., use in about 80 medical and surgical specialties are provided by the present invention.

From hundreds of thousands of logical permutations, combinations or relationships of said words, terms, phrases and codes use by physicians, a few examples are presented infra wherein n=0-31 days (although week(s), month(s) and year(s) may and can be used), and alphabets x, o, p, q, r, s and t appearing before each heading infra represents pertinent, appropriate or relevant chief complaints, diagnoses, tests, prescriptions, treatments, surgeries and recommendations, etc. in medicine and surgery and the symbol “→” infra serves to describe or represent one of the preferred embodiments of the present invention—the relationships of related words, terms, phrases, acronyms, synonyms and codes in medicine and surgery use by physicians.

x CHIEF COMPLAINTS→n DURATIONS→o DIAGNOSES (or Dx)→p TESTS→q PRESCRIPTIONS→r TREATMENTS (or Rx)→s SURGERIES (or Sx)→t RECOMMENDATIONS or (Rc) First Example Template I—a hierarchy, lattice, order of related words, terms, phrases, codes, acronyms and synonyms applicable to a medical specialty of said medical and surgical specialties such as, but not limited to, neurology:
Headache→n Days→o Dx→p Tests→q Prescriptions→r Rx→s Sx→t Rc
Headaches→n Days→o Dx→p Tests→q Prescriptions→r Rx→s Sx→t Rc
Head pain→n Days→o Dx→p Tests→q Prescriptions→r Rx→s Sx→t Rc
Headache neck→n Days→o Dx→p Tests→q Prescriptions→r Rx→s Sx→t Rc
Head pain neck pain→n Days→o Dx→p Tests→q Prescriptions→r Rx→s Sx→t Rc
Headache tender neck→n Days→o Dx→p Tests→q Prescriptions→r Rx→s Sx→t Rc
Headache painful neck→n Days→o Dx→p Tests→q Prescriptions→r Rx→s Sx→t Rc
Headache neck pain→n Days→o Dx→p Tests→q Prescriptions→r Rx→s Sx→t Rc
Headache neck ache→n Days→o Dx→p Tests→q Prescriptions→r Rx→s Sx→t Rc
Headache neck stiffness→n Days→o Dx→p Tests→q Prescriptions→r Rx→s Sx→t Rc
Headache neck spasm→n Days→o Dx→p Tests→q Prescriptions→r Rx→s Sx→t Rc
Headache stiff neck muscle→n Days→o Dx→p Tests→q Prescriptions→r Rx→s Sx→t Rc
Headache muscle spasm→n Days→o Dx→p Tests→q Prescriptions→r Rx→s Sx→t Rc
Headache nausea→n Days→o Dx→p Tests→q Prescriptions→r Rx→s Sx→t Rc
Headache dizziness→n Days→o Dx→p Tests→q Prescriptions→r Rx→s Sx→t Rc
Headache nausea dizziness→n Days→o Dx→p Tests→q Prescriptions→r Rx→s Sx→t Rc
Headache neck stress→n Days→o Dx→p Tests→q Prescriptions→r Rx→s Sx→t Rc
Headache stressed neck→n Days→o Dx→p Tests→q Prescriptions→r Rx→s Sx→t Rc
Headache neck injury→n Days→o Dx→p Tests→q Prescriptions→r Rx→s Sx→t Rc
Headache injured neck→n Days→o Dx→p Tests→q Prescriptions→r Rx→s Sx→t Rc
Headache brain injury→n Days→o Dx→p Tests→q Prescriptions→r Rx→s Sx→t Rc
Headache brain disorders→n Days→o Dx→p Tests→q Prescriptions→r Rx→s Sx→t Rc
Headache fever→n Days→o Dx→p Tests→q Prescriptions→r Rx→s Sx→t Rc
Headache chills→n Days→o Dx→p Tests→q Prescriptions→r Rx→s Sx→t Rc
Headache fever chills→n Days→o Dx→p Tests→q Prescriptions→r Rx→s Sx→t Rc
Headache neck mass→n Days→o Dx→p Tests→q Prescriptions→r Rx→s Sx→t Rc
Headache tender neck mass→n Days→o Dx→p Tests→q Prescriptions→r Rx→s Sx→t Rc
Headache front neck pain→n Days→o Dx→p Tests→q Prescriptions→r Rx→s Sx→t Rc
Headache weight loss fever→n Days→o Dx→p Tests→q Prescriptions→r Rx→s Sx→tRc
Headache labor→n Days→o Dx→p Tests→q Prescriptions→r Rx→s Sx→t Rc
Headache postpartum→n Days→o Dx→p Tests→q Prescriptions→r Rx→s Sx→t Rc
Headache labor postpartum→n Days→o Dx→p Tests→q Prescriptions→r Rx→s Sx→t Rc
Headache lumbar puncture→n Days→o Dx→p Tests→q Prescriptions→r Rx→s Sx→t Rc
Headache recurring sudden→n Days→o Dx→p Tests→q Prescriptions→r Rx→s Sx→t Rc
Recurring sudden headache→n Days→o Dx→p Tests→q Prescriptions→r Rx→s Sx→t Rc

Second Example Template II: the word “Migraine” or “Migraines” can substitute for said words “Headache” or “Headaches” to produce another hierarchy, lattice, order of related words, terms, phrases, codes, acronyms and synonyms applicable to a medical specialty of said medical and surgical specialties such as, but not limited to, oral surgery.

Third Example Template III—another hierarchy, lattice or order of related words, terms, phrases, codes, acronyms and synonyms applicable to a medical specialty such as, but not limited to, neurology, headache specialist or infectious disease specialist:
Face pain→n Days→o Dx→p Tests→q Prescriptions→r Rx→s Sx→t Rc
Facial pain→n Days→o Dx→p Tests→q Prescriptions→r Rx→s Sx→t Rc
Face pain stiff neck→n Days→o Dx→p Tests→q Prescriptions→r Rx→s Sx→t Rc
Face pain neck stiffness→n Days→o Dx→p Tests→q Prescriptions→r Rx→s Sx→t Rc
Face pain calf pain→n Days→o Dx→p Tests→q Prescriptions→r Rx→s Sx→t Rc
Face pain blisters→n Days→o Dx→p Tests→q Prescriptions→r Rx→s Sx→t Rc
Face Face pain blister crops→n Days→o Dx→p Tests→q Prescriptions→r Rx→s Sx→t Rc
Face pain crops of blisters→n Days→o Dx→p Tests→q Prescriptions→r Rx→s Sx→t Rc Face pain nasal discharge→n Days→o Dx→p Tests→q Prescriptions→r Rx→s Sx→t Rc
Face pain nasal pus→n Days→o Dx→p Tests→q Prescriptions→r Rx→s Sx→t Rc
Face pain stabbing pain→n Days→o Dx→p Tests→q Prescriptions→r Rx→s Sx→t Rc
Stabbing face pain→n Days→o Dx→p Tests→q Prescriptions→r Rx→s Sx→t Rc
Recurrent face pain→n Days→o Dx→p Tests→q Prescriptions→r Rx→s Sx→t Rc
Face pain weakness→n Days→o Dx→p Tests→q Prescriptions→r Rx→s Sx→t Rc
Face pain numbness→n Days→o Dx→p Tests→q Prescriptions→r Rx→s Sx→t Rc
Face pain numbness weakness→n Days→o Dx→p Tests→q Prescriptions→r Rx→s Sx→t Rc
Face pain chewing pain→n Days→o Dx→p Tests→q Prescriptions→r Rx→s Sx→t Rc
Face chewing pain→n Days→o Dx→p Tests→q Prescriptions→r Rx→s Sx→t Rc
Face pain chest pain→n Days→o Dx→p Tests→q Prescriptions→r Rx→s Sx→t Rc
Face pain chest heaviness→n Days→o Dx→p Tests→q Prescriptions→r Rx→s Sx→t Rc Face pain chest heaviness pain→n Days→o Dx→p Tests→q Prescriptions→r Rx→s Sx→tRc
Face pain fever→n Days→o Dx→p Tests→q Prescriptions→r Rx→s Sx→t Rc
Face pain trauma→n Days→o Dx→p Tests→q Prescriptions→r Rx→s Sx→t Rc

It is understood that many logical orders, uses, permutations, combinations or relationships of headings or categories including the uses of additional or many more or less headings are provided by the present invention. Consequently, the logical orders, uses, permutations, combinations or relationships of words, terms, acronyms and phrases in said headings or categories follow supra. For example, 2 representations or permutations of the orders or relationships of headings supra are as follow:

o DIAGNOSES (or Dx)→×CHIEF COMPLAINTS→n DURATIONS→p TESTS→q PRESCRIPTIONS→r TREATMENTS (or Rx)→s SURGERIES (or Sx)→t RECOMMENDATIONS or (Rc)

x CHIEF COMPLAINTS→n DURATIONS→o DIAGNOSES (or Dx)→p TESTS→q PRESCRIPTIONS→r TREATMENTS (or Rx)→s SURGERIES (or Sx)→t RECOMMENDATIONS (or Rc)→REFERRALS (or Re)

It is understood that said categories or headings of complaints or chief complaints, durations, diagnoses, differential diagnoses, prescriptions and dosages, tests, treatments, surgeries, recommendations, referrals, a means for representing sets of data and all related comprise vocabulary of words, terms, phrases and sentences use by physicians and the applications of said categories or headings according to the spirit and scope of the claims of the present invention are based on the concepts and fundamentals of the practices of medicine and surgery.

Thus, in each of said medical or surgical specialties, the complaints or chief complaints comprise hundreds or thousands of words, term and/or phrases such as, but not limited to,
Headache, stomach ache, fever, malaise, neck pain, neck stiffness, frequent falls and any logical combination of said hundreds or thousands of words and terms; diagnoses comprise hundreds or thousands of words, terms and/or phrases such as, but not limited to, neuropathy, diabetic neuropathy, small fiber neuropathy, peripheral neuropathy, Bell's palsy, myofascial pain syndrome, cervicobrachial pain syndrome and any logical combinations of said hundreds or thousands of words and terms use by physicians in their communications and records of said information. Similarly, said explanations of concepts and fundamentals are applied to differential diagnoses, prescriptions and dosages, tests, treatments, surgeries, recommendations, referrals, a means for representing sets of data and related, etc. Of course, durations, date and time comprise second, minute, hour, day, week, month, year and date—in singular or pleural.

Further to same, because of the graphic limitation on paper, the three template examples I-III supra of possible hundreds-thousands of templates provide by the present invention merely illustrate small horizontal linkages of said logical relationships of said words, terms, phrases, acronyms, synonyms and codes. Based on the preferred embodiments and the objectives and scope of the claims of the present invention, however, it is understood the most versatile lattices, webs, arrangements or templates comprising horizontal, vertical and oblique relationships of medical and surgical vocabularies comprising said words, terms, phrases, acronyms, synonyms, codes and even sentences in about 80 medical and surgical specialties are provided by the present invention to fulfill the needs, applications or uses of a physician, a group of physicians, groups or organizations of physicians.

Furthermore, the present invention also provides the most useful and effective means for reducing or eliminating redundancies of applications or uses of supra.

The means for representing sets of data comprises codes, terms, phrases, sentences, acronyms, synonyms, abbreviations representing corresponding templates of information, flowsheets, descriptions, protocols, formulas, formularies, sets of writings or information, definitions, instructions, illustrations, citations, documentations, charts, logics and the like which are commonly or repetitively use, repeat, recite, used, repeated or recited by physicians of any and all medical and surgical specialties and health-care. Therefore, said physicians do not have to repetitively and extensively dictate information which are routinely and repetitively use by said physicians.

Said means for representing sets of data are created and used in medicine and surgery. Said means for representing sets of data can be subcategories or elements of said categories or headings of chief complaints, durations, diagnoses, differential diagnoses, prescriptions and dosages, tests, treatments, surgeries, recommendations, referrals, and related, etc.

For example, a surgeon uses codes, words or terms such as, but not limited to, “protocol 1”, “protocol 2”, “protocol 3” and so on to represent surgical removal of gall bladder procedure, surgical removal of appendix procedure, surgical removal of spleen procedure and so on and the like, respectively. The procedures are documented in great details in printed and/or electronic formats.

For example, an internist uses codes, words or phrases such as “knee joint steroid”, “trigger point injection”, “mmr vaccination” and so on to represent full and detailed documented descriptions of medical and surgical procedures of injection of steroid into a knee joint, injection of lidocaine solution into a trigger point for the management of pain, a vaccination of MMR vaccine in a child and so on and the like, respectively. Said descriptions are documented in great details in printed and/or electronic formats.

Said means for representing sets of data comprises hundreds or thousands of codes, words, terms or abbreviations comprising all uses of data repetitively and routinely use in about 80 medical and surgical specialties and health-care.

It is to be understood that each alphabet—x, o, p, q, r, s and t—appearing before each heading, word, term, abbreviation and code, etc. supra representing complaints or chief complaints, diagnoses, tests, prescriptions including dosages, treatments, surgeries and recommendations, etc. in medicine and surgery may or may not be same or equal value between lines. A zero value may also be assigned.

In other words, showing infra two relationships supra, the first relationship of words, terms, acronyms and codes and abbreviations use in medicine or surgery:
Headache→n Days→o Dx→p Tests→q Prescriptions→r Rx→s Sx→t Rc
   is provided by the present invention as illustrate infra by a very small sample of relationships of words, terms, codes and abbreviations in medicine and surgery:
Headache→1 Day→Common Migraine→no Test→Oral imitrex
   →1 Day→Cervicogenic headache→Neck x-ray→Oral motrin
   →1 Day→Muscular tension headache→Neck x-ray→Oral muscle relaxant ibuprofen→Rest
   →1 Day→Cervicogenic headache→Neck x-ray→Oral tylenol # 3
   →3 Days→Cluster headache→Brain CTScan→IM imitrex→Neurosurgery
   →4 Days→Sinus headache→Sinus CTScan→Oral decongestant→ENT
   →30 Days→Cervical radiculitis→Neck MRI→Epidural Steroid→PMR
   →60 Days→Cervicogenic headache→Neck MRI→Oral motrin→PT
      and so on.

The second relationship of words, terms, codes and abbreviations use in medicine or surgery:
Headache fever→n Days→o Dx→p Tests→q Prescriptions→r Rx→s Sx→t Rc
   is provided by the present invention as illustrate infra by a very small sample of relationships of words, terms, acronyms, codes and abbreviations in medicine and surgery:
Headache fever→1 Day→Common viral cold→Fluid Rest Oral vitamin c
   →5 Days→Respiratory infection→Blood test→Oral Acyclovir→Rest
   →10 Days→Meningitis→Lumbar puncture→IV penicillin→ID consultation
   →10 Days→Meningitis→Lumbar puncture Brain ctscan→IV aminoglycosides→ID consultation
   →10 Days→Meningitis→Lumbar puncture Brain ctscan Sputum culture→IV gentamycin→ID Neurosurgery consultations
   →10 Days→Meningitis→Lumbar puncture Brain ctscan Sputum gram stain culture→IV gentamycin→ID Neurosurgery consultations
   →10 Days→Meningitis→Lumbar puncture Brain ctscan Sputum CSF fluid gram stain culture→IV gentamycin→ID consultation
   →30 Days→Amebic encephalopathy→Blood test Brain ctscan→IV antibiotics→ICU Intubation
   →30 Days→Amebic encephalopathy→Blood test Brain ctscan Lumbar puncture→IV pentamadine→ICU Intubation Respiratory support
   →30 Days→Amebic encephalopathy→Blood test Brain ctscan Lumbar puncture India ink stain CSF fluid→IV pentamadine→ICU Intubation Respiratory support
   →90 Days→AIDS Parasitic encephalopathy meningitis→Blood test→IV pentamadine→ICU
   →90 Days→AIDS Parasitic encephalopathy meningitis→Blood test Brain ctscan Lumbar puncture→IV antibiotics Pentamadine→ICU Intubation Respiratory support
   →90 Days→AIDS Parasitic encephalopathy meningitis→Blood test Brain ctscan Lumbar puncture India ink stain CSF fluid→IV antibiotic cocktails Pentamadine→ICU Intubation Respiratory support
      and so on.

Furthermore, an individual hierarchy or order is further designed to meet the idiosyncrasy of the application or use of said words, terms, phrases, acronyms, synonyms and/or codes of any physician, a group of physicians or a plurality of groups or organizations of physicians. For example, a surgeon, an opthalmologist, an orthopaedist, a urologist or a gynecologist, etc. can choose to use a list, lists or template or templates of prioritized words, terms, phrases, acronyms, synonyms and/or codes in said categories or headings which he/she commonly or repetitively uses in his/her field of surgery or specialty and related. Similarly, a neurologist, an endocrinologist, a pediatrician, an internist or a family practitioner, etc. can choose to use a list, lists or template or templates of prioritized words, terms, phrases, acronyms, synonyms and/or codes in said categories or headings which he/she commonly or repetitively uses in his/her specialty and related. Similarly, a group of endocrinologists or an organizations of family practitioners, etc. can choose to use a list, lists or template or templates of prioritized words, terms, phrases, acronyms, synonyms and/or codes in said categories or headings which they commonly or repetitively uses in their specialties and related.

In other words, the present physician patent applicant presents above two crude examples of simple and rudimentary templates, another physician, a group of physicians or groups or organizations of physicians will use better, more detailed and extensive versions of templates comprising greater details and sophistication of categories or headings, words, terms, phrases, acronyms, synonyms and/or codes in medicine, surgery and health-care according to the spirit and scope of the claims of the present invention.

Based on the explanations and illustrations herein, it is understood that number of complaints or chief complaints, diagnoses, tests, prescriptions including dosages, treatments, surgeries, recommendations, referrals, and related, etc. under each category or heading—Complaint or Chief Complaint, Duration, Diagnosis, Differential Diagnosis, Prescription and dosages, Test, Treatment, Surgery, Recommendation, Referral, and related, etc., respectively—may and will be different for different templates and for different physicians, groups or organizations of physicians.

Further to supra, based on the explanations and illustrations herein, it is understood that information of complaints or chief complaints, diagnoses, tests, prescriptions including dosages, treatments, surgeries, recommendations, referrals, and related, etc. under each category or heading—Complaint or Chief Complaint, Duration, Diagnosis, Differential Diagnosis, Prescription and dosages, Test, Treatment, Surgery, Recommendation, Referral, and related, etc., respectively—may and will be different for different templates and for different physicians, groups or organizations of physicians.

Yet another of the preferred embodiments of the present invention is the individual applications or uses of lists of prioritized words, terms, phrases, acronyms, synonyms and/or codes in said categories or headings which are commonly and repetitively used by a physician, a group of physicians or groups or organizations of physicians and other health-care providers. In other words, the vocabulary of words, terms, phrases, acronyms, synonyms and/or codes use by a physicians, a group of physicians or groups or organizations of physicians of a medical or surgical specialty is very large—see medical dictionary and medical specialty textbooks. But most of entire said vocabulary is not used daily, routinely or at all in speech recognition. Therefore, a physician, a group of physicians or groups or organizations of physicians and other health-care providers can apply or give priority to the lists of prioritized words, terms, phrases, acronyms, synonyms and/or codes in said categories or headings which serve his, her or their applications and needs to achieve the objectives and goals of the present invention. Of course, said priority means also said physician, group of physicians, groups or organizations of physicians can and will created or generated, revised, edited, expanded and improved the templates to meet and fulfill his, her or their needs, applications or demands.

Further to supra, it is understood that the above process also comprises a process of using words, numbers, terms, phrases and sentences that are not in a physician's medical or surgical specialty or practice. In other words, in order to effectively communicate, document or record information and to generate meaningful, accurate or correct health and health-care information on a patient and patients by a physician in his/her clinical practice, a physician can and will incorporate non-medical and other medical and surgical words, numbers, terms, phrases and sentences from other medical and surgical specialties outside his/her specialty in the construction of terms, phrases and/or sentences in the digital data in the claims of the present invention. For example, any physician such as, but not limited to, a neurologist can and will generate words, numbers, terms, phrases and sentences relating to his/her neurology specialty or practice and to other medical and surgical specialties such as, but not limited to, endocrinology, rheumatology, orthopaedics, urology, nephrology and pharmacology. Said examples apply to all physicians belonging to 70 medical and surgical specialties such as, but not limited to, allergists, endocrinologists, immunologists, gastroenterologists, nephrologists, oncologists, radiologists, general surgeons and plastic surgeons.

The present invention provides the medical speech grammars and rules for physicians and/or other health-care providers in U.S.A. and other countries to maximize or optimize the efficient uses and applications of the speech recognition technology of converting digital voice data of health and health-care information and data on patients generated by physicians to digital text data. Said process of conversions is taught by the present physician patent applicant in earlier patent applications. The present invention provides physicians—a physician, a group of physicians, groups of physicians—said grammars and rules to produce or generate templates of related words, terms, phrases, codes and the like which are saved in files. Furthermore, said grammars, rules and templates can be created or generated, revised, edited, expanded and improved by a physician, a group of physicians, groups of physicians to fulfill his, her or their needs, applications or demands.

As taught in Ser. No. 11/255,229 entitled the Best method of computerized transcriptions filed Oct. 21, 2005, in order for said physicians to effectively communicate, document or record information and to generate meaningful, accurate or correct health and health-care information on a patient and patients by said physicians, the present invention provides the incorporations of non-medical words, numbers, terms, phrases, sentences, acronyms, synonyms, codes and labels.

Furthermore, as taught in Ser. No. 11/255,229 entitled the Best method of computerized transcriptions filed Oct. 21, 2005, the present invention further provides a process of labeling or tagging individual physicians' digital data with individual corresponding physicians' medical or surgical specialties. The computer-automated process is the preferred embodiments of achieving said labeling process. In other words, computers including digital voice records and servers label or tag individual physicians' individual digital voice data with said physicians' corresponding medical or surgical specialties with corresponding medical or surgical specialties of said physicians. For example, a computer including digital voice record and server can label or tag an endocrinologist's digital voice data on any and all of said endocrinologist's data with the endocrinology specialty in a form of code, label, tag or the like. Similarly, a computer including digital voice record and server can label or tag a neurosurgeon's digital voice data on any and all of said neurosurgeon's data with the neurosurgery specialty in the form of a code, label or the like. The above settings and processes are repeated for each and all physicians in about 80 medical and surgical specialties using the present invention every time. Said examples apply to all physicians belonging to 80 medical and surgical specialties. The above applies to physicians' digital voice data and digital text data.

Thus, the preferred embodiments of the present invention provide a physician, a group of physicians, groups or organizations of physicians in all medical and surgical specialties the means for achieving the goals and objectives of the present invention.

The present invention applies to the multi-modal applications and many electronic equipments such as, but not limited to, hand-held devices such as, but not limited to, digital voice recorders, mobile devices such as, but not limited to, cellular phones, smartphones and equipment and the like, telephony, computers, servers and the Internet to achieve the goals and objectives of the present invention.

The abbreviations supra such as Dx, Rx and Sx, etc. are used herein only for illustration due to the limitation of the width of the pages. In practice, it is not likely that these abbreviations will be used by the physicians.

It is understood that said vocabulary, words and terms comprises the contents of many good and comprehensive medical, surgical and specialty texts of about 80 medical and surgical specialties and dictionary. Illustrations, drawings, pictures, schematics and the like are also included.

The words medicine, medical, medical specialty and medical specialties in the claims and supra of the present invention are to be understood to mean or include medicine, surgery, medical and/or surgical specialty or specialties. Furthermore, the words and terms used in the claims can also include items described supra such as, but not limited to, phrases, codes, acronyms, synonyms, and/or sentences where and when applicable.

Although various preferred embodiments of the present invention have been described for physicians and other health-care providers, it will be appreciated by those skilled in the art that adaptations and variations may be made to apply to people using electronic equipment such as, but not limited to, computers, laptops, hand-held devices, smartphones, cordless devices using wireless technologies and the like and other businesses and industries such as, but not limited, law, lawyers and government and their clients, veterinarians and animals, engineering and engineers without departing from the spirit of the invention and the scope of the claims.

Although various preferred embodiments of the present invention have been described, it will be appreciated by those skilled in the art that adaptations and variations may be made without departing from the spirit of the invention and the scope of the claims.

1. A system of hierarchies of words and terms use in medicine and surgery for optimizing the outcomes of speech recognition process of converting digital voice data produced by physicians into digital text data comprises:
words and terms use in a medical specialty;
words and terms use in a surgical specialty;
a means for representing sets of information;
words and terms use in a plurality of medical specialties;
words and terms use in a plurality of surgical specialties;
an order of related words and terms use in a medical specialty;
an order of related words and terms use in a surgical specialty;
a plurality of individual orders of words and terms use in a medical specialty;
a plurality of individual orders of words and terms use in a surgical specialty;
a plurality of individual orders of words and terms use in individual medical specialties;
a plurality of individual orders of words and terms use in individual surgical specialties;
inclusions of words and terms use in a plurality of medical and surgical specialties in said words and terms use in a medical specialty;
inclusions of words and terms use in a plurality of medical and surgical specialties in said words and terms use in a surgical specialty;
inclusions of words and terms use in a plurality of medical and surgical specialties in individual orders of words and terms use in a plurality of medical specialties; and
inclusions of words and terms use in a plurality of medical and surgical specialties in individual orders of words and terms use in a plurality of surgical specialties.

2. The system according to claim 1 wherein said plurality of individual orders of words and terms use in a medical specialty include a plurality of relationships of words and terms use in a medical specialty.

3. The system according to claim 1 wherein said plurality of individual orders of words and terms use in a surgical specialty include a plurality of relationships of words and terms use in a surgical specialty.

4. The system according to claim 1 wherein said plurality of individual orders of words and terms use in a medical specialty include a plurality of relationships of words and terms use in medical and surgical specialties.

5. The system according to claim 1 wherein said plurality of individual orders of words and terms use in a surgical specialty include a plurality of relationships of words and terms use in medical and surgical specialties.

6. The system according to claim 1 wherein said order of related words and terms use in a medical specialty comprises related words and terms in medicine.

7. The system according to claim 1 wherein said order of related words and terms use in a surgical specialty comprises related words and terms in surgery.

8. The system according to claim 1 wherein said inclusion of words and terms use in a plurality of medical specialties in said order of words and terms use in said medical specialty comprises related words and terms in medicine.

9. The system according to claim 1 wherein said means for representing sets of data comprises a plurality of codes.

10. The system according to claim 1 wherein said means for representing sets of data comprises a plurality of acronyms.

11. A system of templates of related words and terms use in medicine and surgery for improving the outcomes produce by the speech recognition process of converting digital voice data generated by physicians to digital text data comprises:
words and terms use in a medical specialty;
words and terms use in a surgical specialty;
a means for representing sets of information;
words and terms use in a plurality of medical specialties;
words and terms use in a plurality of surgical specialties;
an order of related words and terms use in a medical specialty;
an order of related words and terms use in a surgical specialty;
a plurality of individual orders of words and terms use in a medical specialty;
a plurality of individual orders of words and terms use in a surgical specialty;
a plurality of individual orders of words and terms use in individual medical specialties;
a plurality of individual orders of words and terms use in individual surgical specialties;
inclusions of words and terms use in a plurality of medical and surgical specialties in said words and terms use in a medical specialty;
inclusions of words and terms use in a plurality of medical and surgical specialties in said words and terms use in a surgical specialty;
inclusions of words and terms use in a plurality of medical and surgical specialties in individual orders of words and terms use in a plurality of medical specialties; and
inclusions of words and terms use in a plurality of medical and surgical specialties in individual orders of words and terms use in a plurality of surgical specialties.

12. A grammar means for relating words and terms use in medicine and surgery by physicians for improving the accuracy of the speech recognition process of converting digital voice data generated by physicians to digital text data comprises:
words and terms use in a medical specialty;
words and terms use in a surgical specialty;
a means for representing sets of information;
words and terms use in a plurality of medical specialties;
words and terms use in a plurality of surgical specialties;
an order of related words and terms use in a medical specialty;
an order of related words and terms use in a surgical specialty;
a plurality of individual orders of words and terms use in a medical specialty;
a plurality of individual orders of words and terms use in a surgical specialty;
a plurality of individual orders of words and terms use in individual medical specialties;
a plurality of individual orders of words and terms use in individual surgical specialties;
inclusions of words and terms use in a plurality of medical and surgical specialties in said words and terms use in a medical specialty;
inclusions of words and terms use in a plurality of medical and surgical specialties in said words and terms use in a surgical specialty;
inclusions of words and terms use in a plurality of medical and surgical specialties in individual orders of words and terms use in a plurality of medical specialties; and
inclusions of words and terms use in a plurality of medical and surgical specialties in individual orders of words and terms use in a plurality of surgical specialties.
